(19) United States
(12) Patent Application Publication
(10) Pub. No.: US 2018/0146136 A1
(43) Pub. Date: May 24, 2018

(54) FULL-SPHERICAL VIDEO IMAGING SYSTEM AND COMPUTER-READABLE RECORDING MEDIUM

(71) Applicant: Hideaki YAMAMOTO, Kanagawa (JP)

(72) Inventor: Hideaki YAMAMOTO, Kanagawa (JP)

(21) Appl. No.: 15/578,282

(22) PCT Filed: Jun. 28, 2016
(86) PCT No.: PCT/JP2016/003104

§ 371 Date: Nov. 30, 2017

(30) Foreign Application Priority Data
Jul. 1, 2015 (JP) 2015-132564
Jun. 23, 2016 (JP) 2016-124881

(51) Int. Cl. H04N 5/232; H04N 5/225

(52) U.S. Cl. CPC H04N 5/23238; H04N 5/2251; H04N 5/2259; H04N 5/23229

(57) ABSTRACT

A full-spherical video imaging system includes an acquisition unit configured to acquire tilt angles relative to a vertical direction from an image sensor with a second cycle time being shorter than a first cycle time with which the acquisition unit acquires original image data from the image sensor, a calculator configured to calculate an average tilt angle from a tilt angle of the image sensor relative to the vertical direction acquired simultaneously with acquisition of the original image data and a tilt angle of the image sensor relative to the vertical direction acquired in a period straddling the acquisition of the original image data, and a generator configured to generate corrected image data by correcting the original image data based on the average tilt angle.

### TECHNICAL FIELD

The present invention relates to a full-spherical video imaging system and a computer-readable recording medium.

### BACKGROUND ART

Conventionally, as an apparatus that captures an omnidirectional (or full-spherical) image, that which uses a hyperboloidal mirror(s), that which uses a fisheye lens(es), or the like is known. Some of these apparatuses capture a hemispherical or full-spherical still image with one shot.

A technique of cutting out a part of a distorted circular image where a hemisphere is recorded by wide-angle image capture using a fisheye lens and transforming the distorted image into a planar regular image by performing computer image processing is already known.

Another technique, which is to be applied to such image processing, of causing, when a center position of the distorted circular image does not correctly coincide with the zenith direction, a user to specify a parameter for a tilt angle, thereby reducing a load imposed by image distortion correction is also already known.

Thus, there is a problem that, when an image is captured with an image capture apparatus in a tilted orientation, an omnidirectional (full-spherical) image that is incorrect in vertical direction can be generated. Inventions for solving this have been already known.

Patent Literature 1 discloses a method and a configuration of equipment for transforming each frame image of a video to record a full-spherical video where upward vertical direction is consistently correct even if the video is captured with a main body of a video capture apparatus including two fisheye lenses and an acceleration sensor tilted. This is achieved by recording two fisheye videos and performing, after capturing the videos, zenith correction simultaneously with transformation into an equirectangular projection by using data about tilt angles of the main body obtained from the acceleration sensor.

A technique of collecting video information from a domical field of view with a horizontal angle of view of 360 degrees and a vertical angle of view of 180 degrees transmitted full-spherically, or omni-directionallly, by using a specific electromagnetic wave as a data medium is disclosed in Patent Literature 2.

A technique of collecting, as in Patent Literature 2, video information from a domical field of view with a horizontal angle of view of 360 degrees and a vertical angle of view of 180 degrees transmitted full-spherically, or omni-directionallly, by using a specific electromagnetic wave as a data medium is disclosed in Patent Literature 3.

### SUMMARY OF INVENTION

### Technical Problem

It is expected that the above-described problem can be solved by the technique known from Patent Literature 1 for displaying, when image capture is performed using a hand-holdable full-spherical camera with its main body tilted, a still image after applying tilt angle correction. However, a novel problem that fluctuation in output value of the acceleration sensor caused by noises makes it difficult to obtain an angle relative to the vertical direction has arisen.

Patent Literature 2 and Patent Literature 3, which differ from the present invention in technical feature, also cannot solve the novel problem that fluctuation in output value of the acceleration sensor caused by noises makes it difficult to obtain an angle relative to the vertical direction.

In view of the conventional problems, there is a need to provide an imaging system that acquires acceleration sensor data with a cycle time shorter than an image-data-acquisition cycle time to thereby correct a tilt of a main body of a full-spherical camera correctly.

### Solution to Problem

The present invention is characterized by the following features.

According to exemplary embodiments of the present invention, there is provided a full-spherical video imaging system comprising: an acquisition unit configured to acquire tilt angles relative to a vertical direction from an image sensor with a second cycle time of “one over a whole number”, the second cycle time being shorter than a first cycle time with which the acquisition unit acquires original image data from the image sensor; a calculator configured to calculate an average tilt angle from a tilt angle of the image sensor relative to the vertical direction acquired simultaneously with acquisition of the original image data and a tilt angle of the image sensor relative to the vertical direction acquired in a period straddling the acquisition of the original image data; and a generator configured to generate corrected image data by correcting the original image data on the basis of the average tilt angle.

### Advantageous Effects of Invention

According to the present invention, tilt angles of a main body can be obtained highly accurately by setting an acceleration-sensor-data-acquisition cycle time to be shorter than an image-data-acquisition cycle time. Accordingly, it is possible to generate highly-accurate omnidirectional (full-spherical) video images.

### BRIEF DESCRIPTION OF DRAWINGS

FIG. 1 is a functional block diagram describing an imaging system of an embodiment of the present invention.

FIG. 2 is a hardware configuration diagram of an image capture apparatus of the embodiment.

FIG. 3 is a hardware configuration diagram of an information processing apparatus of the embodiment.

FIG. 4 is a diagram illustrating a tilt-angle-acquisition cycle time and an image-data-acquisition cycle time of the embodiment.

FIG. 5A is a diagram describing a projection relationship of a fisheye lens used in the image capture apparatus of the embodiment from an appearance of the fisheye lens in side view.

FIG. 5B is a diagram describing a projection relationship of a fisheye lens used in the image capture apparatus of the embodiment from a projection function f of a captured image in plan view.

FIG. 6A is a diagram describing a format of an omnidirectional (full-spherical) image captured by the image capture apparatus of the embodiment presented in a planar form.

FIG. 6B is a diagram describing a format of an omnidirectional (full-spherical) image captured by the image capture apparatus of the embodiment presented in a spherical form.

FIG. 7 is a schematic diagram describing a tilt of the image capture apparatus of the embodiment.

FIG. 8 is a diagram describing vertical correction calculation for an omnidirectional (full-spherical) image captured by the image capture apparatus of the embodiment using (A) a camera coordinate system and (B) a global coordinate system.

FIG. 9A is a conversion table for an omnidirectional (full-spherical) image captured by the image capture apparatus of the embodiment in terms of a matrix of coordinate values of a post-transformation image and a pre-transformation image.

FIG. 9B is a diagram describing a relationship between coordinate values of the post-transformation image and coordinate values of the pre-transformation image.

FIG. 10 is a flowchart for the image capture apparatus of the embodiment.

FIG. 11 is a flowchart for the information processing apparatus of the embodiment.

FIG. 12 is a set of images obtained by joining images captured with two fisheye lenses and having undergone tilt angle correction of the embodiment.

FIG. 13 is a set of images obtained by joining images captured with two fisheye lenses but having not undergone the tilt angle correction of the embodiment. The accompanying drawings are intended to depict exemplary embodiments of the present invention and should not be interpreted to limit the scope thereof. Identical or similar reference numerals designate identical or similar components throughout the various drawings.

### DESCRIPTION OF EMBODIMENTS

The terminology used herein is for the purpose of describing particular embodiments only and is not intended to be limiting of the present invention.

As used herein, the singular forms “a”, “an” and “the” are intended to include the plural forms as well, unless the context clearly indicates otherwise.

In describing preferred embodiments illustrated in the drawings, specific terminology may be employed for the sake of clarity. However, the disclosure of this patent specification is not intended to be limited to the specific terminology so selected, and it is to be understood that each specific element includes all technical equivalents that have the same function, operate in a similar manner, and achieve a similar result.

Embodiments for implementing the present invention are described in detail with reference to the drawings. In the drawings, identical or equivalent elements are denoted by like reference symbols, and repeated description thereof is simplified or omitted as appropriate. In a present embodiment, an omnidirectional (full-spherical) image capture apparatus detects a vertical direction and corrects a conversion table for use in image processing according to the vertical direction at generation of an omnidirectional (full-spherical) image. The term imaging system is used to refer to a plurality of apparatuses, e.g., a digital camera and an information processing apparatus, used separately. In the present embodiment, the term image capture apparatus conceptually includes imaging system unless otherwise specified.

In an example of a most preferred embodiment of the present invention, a full-spherical camera is used as the image capture apparatus, and an image forming apparatus is used as the information processing apparatus.

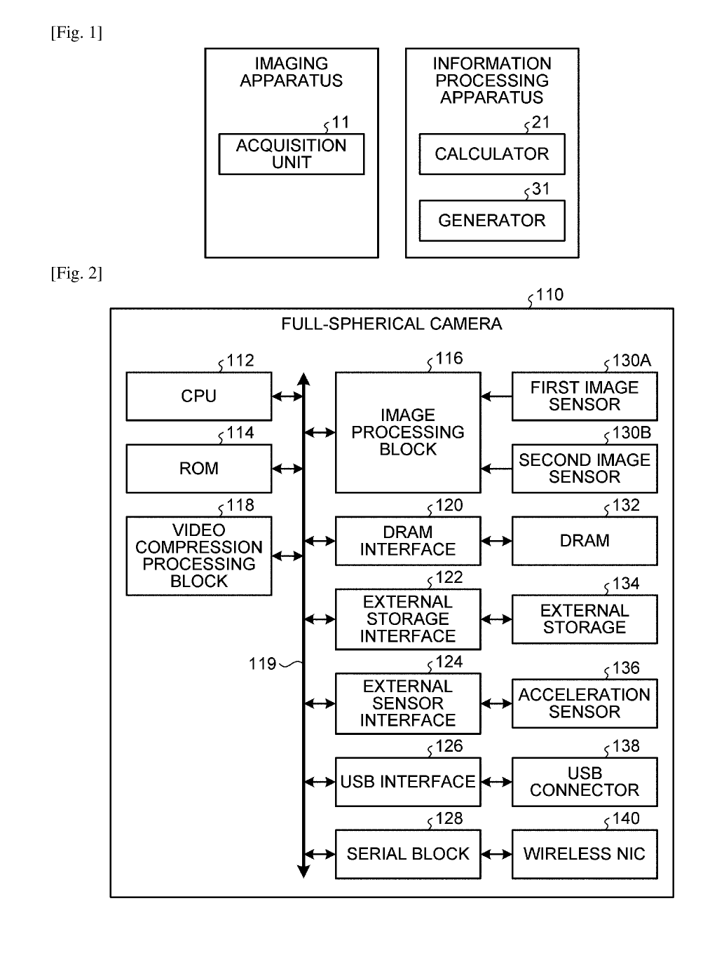

Functional blocks of the present embodiment are described below. FIG. 1 illustrates functional blocks of an imaging system of the present embodiment. The image capture apparatus used in the present embodiment includes an acquisition unit 11; the information processing apparatus includes a calculator 21 and a generator 31.

The acquisition unit 11 acquires tilt angles relative to the vertical direction from an acceleration sensor with a cycle time shorter than an image-data-acquisition cycle time. The acceleration sensor is a three-axis acceleration sensor that detects acceleration of the image capture apparatus in three-axial directions orthogonal to each other, which are up and down, right and left, and near and far directions. For instance, when the image capture apparatus is hand-held still, the acceleration sensor detects only gravitational acceleration.

After the tilt angles are acquired, image data is compressed into video data. At this time, information about the tilt angles is recorded in frame-by-frame video data.

Because the tilt angles relative to the vertical direction are acquired with the cycle time shorter than the image-data-acquisition cycle time, not only information about tilt angles in sync with acquisition of image data but also information about tilt angles out of sync with the acquisition of the image data are recorded. Accordingly, information about a plurality of tilt angles is contained for a single image data piece. This will be described in detail later.

The calculator 21 calculates, based on the plurality of tilt angles that are in sync on a per-frame basis, an average tilt angle relative to the vertical direction for each of the three axial directions.

The average value is not limited to an arithmetic mean value; a median or a mode value may alternatively be used.

The generator 31 corrects a tilt relative to the vertical direction for each frame of the image data using the calculated average tilt angle relative to the vertical direction and, after the tilt angle correction has been correctly made, generates corrected image data on the basis of the corrected data.

To perform the tilt angle correction relative to the vertical direction, tilt angle correction is applied to a predetermined conversion table, which will be described in detail later.

Generating the corrected image data by temporarily converting a video file into a still-image file is undesirably time consuming. For this reason, this processing may be performed on memory without converting the video file.

When the tilt angle correction and generating corrected image data have been performed on every frame, all frames of the image data are joined, thereby generating an equirectangular video.

A hardware configuration of the image capture apparatus is described below. FIG. 2 is a diagram illustrating the hardware configuration of the image capture apparatus of the present embodiment. Referring to FIG. 2, an image capture apparatus (hereinafter, sometimes also referred to as “full-spherical camera”) 110 includes a first image sensor 130A, a second image sensor 130B, a DRAM (Dynamic Random Access Memory) 132, an external storage 134, an acceleration sensor 136, a USB connector 138, a wireless NIC (Network Interface Controller) 140, a CPU (Central Processing Unit) 112, a ROM (Read Only Memory) 114, an image processing block 116, and a video processing block 118. The DRAM 120, the external storage 134, the acceleration sensor 136, the USB connector 138, and the wireless NIC 140 generate respectively a required interface signal thereof by a DRAM interface 120, an external storage interface 122, an external sensor interface 124, a USB interface 126, and a serial block 128 respectively, and are respectively connected to the CPU 112, the ROM 114, the image processing block 116, and the video compression processing block 118 via a BUS 119. And, The DRAM 120, the external storage 134, the acceleration sensor 136, the USB connector 138, and the wireless NIC 140 exchange data such as the image data and the tilt angle respectively with the CPU 112, the ROM 114, the image processing block 116, and the video compression processing block 118.

In the present embodiment, a configuration for obtaining omnidirectional images using two image sensors (so-called “twin-lens system”) is employed. However, the number of the image sensors may alternatively be three or more. When the number of the image sensors is three or more, the lens used in the image sensor does not necessarily have an angle of view of 180 degrees or wider. The angle of view can be adjusted as appropriate. A wide-angle lens, such as a fisheye lens, is typically used as the lens. The image capture apparatus is not limited to an omnidirectional one. An image capture apparatus capable of capturing an image with a horizontal angle of view of 360 degrees may alternatively be used.

The acceleration sensor 136 is used to detect a tilt of the full-spherical camera 110 at image capture. Hence, a tilt direction of the full-spherical camera 110 can be detected instantly and easily.

If an acceleration is detected only in the down direction of the up and down directions, it is indicated that the up and down directions of the full-spherical camera 110 coincide with the vertical direction with respect to the ground surface. In short, it is indicated that the digital camera is held horizontally in a manner in which a digital camera is typically handled.

At image capture, digitized image data is fed to the image processing block 116 by the first image sensor 130A and the second image sensor 130B. The thus-fed image data undergoes image processing performed by using the image processing block 116, the CPU 112, the ROM 114, and the like and, after undergoing video compression, is stored in the DRAM 132. Information about tilt angles acquired by the acceleration sensor 136 is also stored in the DRAM 132 such that the information about the tilt angles is recorded in a stored video file in accordance with predetermined program instructions. After having undergone predetermined processing, the video file is eventually stored in the external storage 134. Examples of the external storage include a CompactFlash (registered trademark) memory and an SD (Secure Digital) memory.

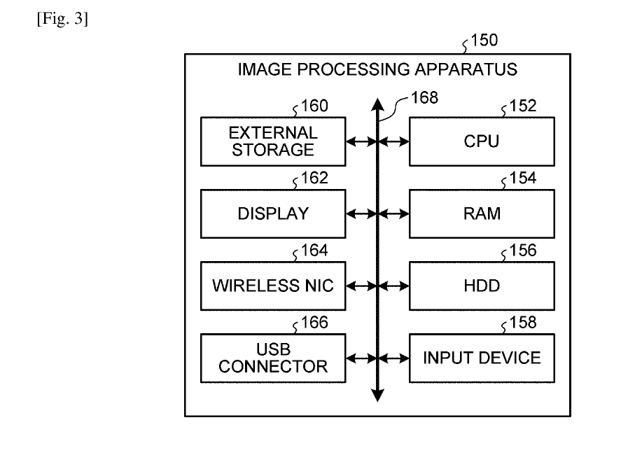

A hardware configuration diagram of the information processing apparatus is described below. FIG. 3 is a hardware configuration diagram of the information processing apparatus of the present embodiment. In the present embodiment, an image forming apparatus is used as an example of the information processing apparatus. The information processing apparatus is not limited to such an image forming apparatus, and may be of any form so long as it provides the functions required of the imaging system of the present invention.

Referring to FIG. 3, an information processing apparatus (hereinafter, sometimes referred to as “image processing apparatus”) 150 includes an external storage 160, a display 162 made up of a liquid crystal or organic electroluminescent panel or the like, a USB connector 166, a wireless NIC 164, a CPU (Central Processing Unit) 152, a RAM (Random Access Memory) 154, an HDD 156, which is a non-volatile memory such as a flash memory, and an input device 158 such as a keyboard, mouse, and a touch panel. The external storage 160, the display 162, the USB connector 166, the wireless NIC 164, the CPU 152, the RAM 154, the HDD 156, and the input device 158 are connected to each other via a BUS 168, and exchange different types of data with each other.

A video file is provided to the image processing apparatus 150 through communication with the full-spherical camera 110. The provided video file is temporarily stored in the HDD 156. The video file is read out from the HDD 156 and decoded into frame-by-frame image data by the CPU 152 in accordance with predetermined program instructions. The video file is temporarily stored in the RAM 154. As described above, each frame of the image data has a plurality of information pieces about tilt angles for each of the directions. The tilt angle in each of the directions of a single frame is calculated as an average value of the plurality of data pieces.

After completion of the calculation of the average tilt angles, the conversion table is corrected using predetermined correcting means depending on the tilt angles, which are angle information in the image data. A method for correcting the conversion table will be described later. Frame-by-frame corrected image data is generated using the corrected conversion table. Processing is iterated until all the frames are transformed.

Generating the corrected image data from the video file in the RAM 154 is performed on memory rather than by temporarily converting the video file stored in the RAM 154 into a still-image file. Performing this processing on memory without converting the video file into still images increases speedup of operation.

When corrected image data has been generated for every frame, the corrected image data is joined to encode it into video data. The encoded video data is stored in the HDD 156 and output to display a video on the display 162, which is a display device, or the like.

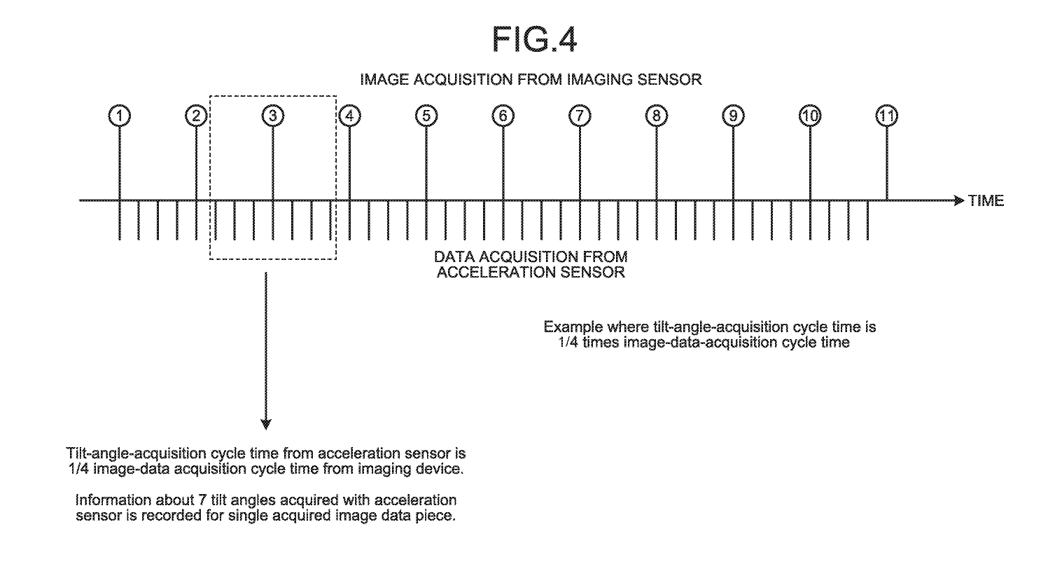

A method for recording tilt angles and image data of the present embodiment is described below. FIG. 4 is a diagram illustrating a tilt-angle-acquisition cycle time and an image-data-acquisition cycle time in image capture with the full-spherical camera. FIG. 4 illustrates an example where the tilt-angle-acquisition cycle time is “¼” the image-data-acquisition cycle time. The tilt-angle-acquisition cycle time is not limited thereto, and may be any cycle time shorter than the image-data-acquisition cycle time, e.g., “⅕” or “ 1/10” the image-data-acquisition cycle time.

In the present embodiment, information about tilt angles that vary depending on tilt of the full-spherical camera is acquired for a video file that is generated during image capture and, furthermore, the information about the tilt angles is recorded in the video file.

The cycle time for acquisition of tilt angles from the acceleration sensor is “¼” the image-data-acquisition cycle time. Accordingly, during when a single image data piece is acquired, the acceleration sensor acquires four tilt angles. It is required that the cycle time, with which the acceleration sensor acquires tilt angles, be constant. This is because if the acquisition cycle time is not constant, reliability of calculated tilt angles relative to the vertical direction decreases.

Referring to FIG. 4, information about seven tilt angles is recorded for a single image data piece. This is because a tilt angle in the same cycle as the image data and tilt angles within preceding three cycles and following three cycles of the cycle are also related to the image data as tilt-angle information.

Referring to FIG. 4, not only the tilt angle acquired simultaneously with acquisition of the image data but all the tilt angles acquired within cycles, of the first cycle time, straddling the acquisition of the image data are related. Alternatively, only two tilt angles, which are a tilt angle immediately before the acquisition of the image data and a tilt angle immediately after the same, may be related. Further alternatively, only information about a tilt angle(s) where noise on acceleration data is small within the cycles, of the first cycle time, straddling the acquisition of the image data may be related. In any case, a condition required of tilt-angle information related to the image data is that the tilt-angle information additionally contains information about a tilt angle(s), which is within the cycles straddling the acquisition of the image data, out of sync with the image-data-acquisition cycle time.

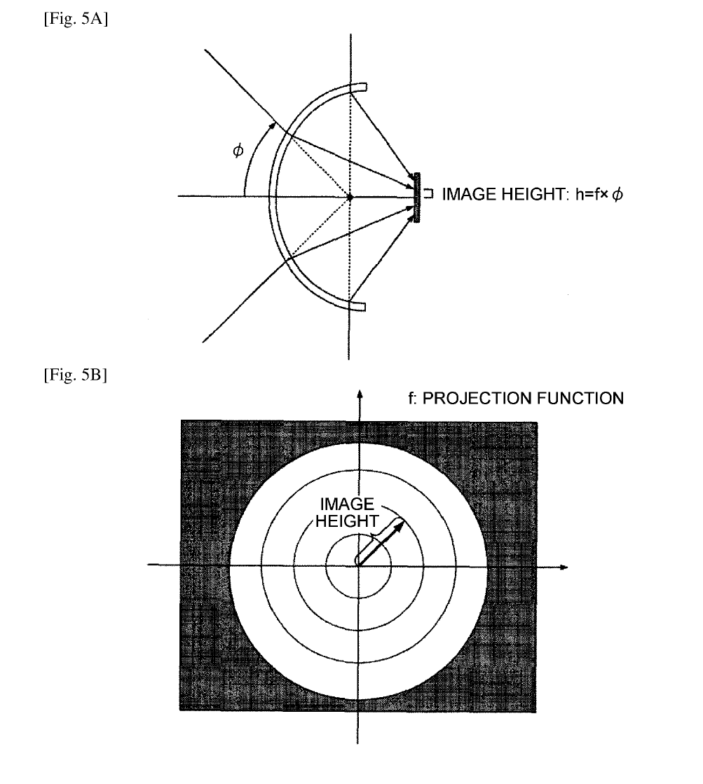

A projection relationship of a fisheye lens, which is an example of a wide-angle lens used in the full-spherical camera of the present embodiment, is described below. FIGS. 5A and 5B are diagrams describing the projection relationship of the fisheye lens used in the digital camera of the embodiment from an appearance of the fisheye lens in side view (FIG. 5A) and a projection function f of a captured image in plan view (FIG. 5B).

An image captured through the fisheye lens having an angle of view wider than 180 degrees is an image of a scene of substantially a half of a sphere cut by a plane passing through its center, which is at an image capture position. As illustrated in (a) and (b) of FIG. 5, the image is generated to have an image height h, which depends on an angle of incidence φ. Relationship between the angle of incidence φ and the image height h is defined by the projection function f (h=f×φ). The projection function varies depending on characteristics of the fisheye lens.

Examples of a method (function) for projective transformation include central projection, stereographic projection, equidistant projection, equi-solid angle projection, and orthographic projection. The central projection is a method used in image capture with a digital camera having a general angle of view. The other four methods are used in digital cameras using a wide-angle lens having an ultra-wide angle of view, such as a fisheye lens.

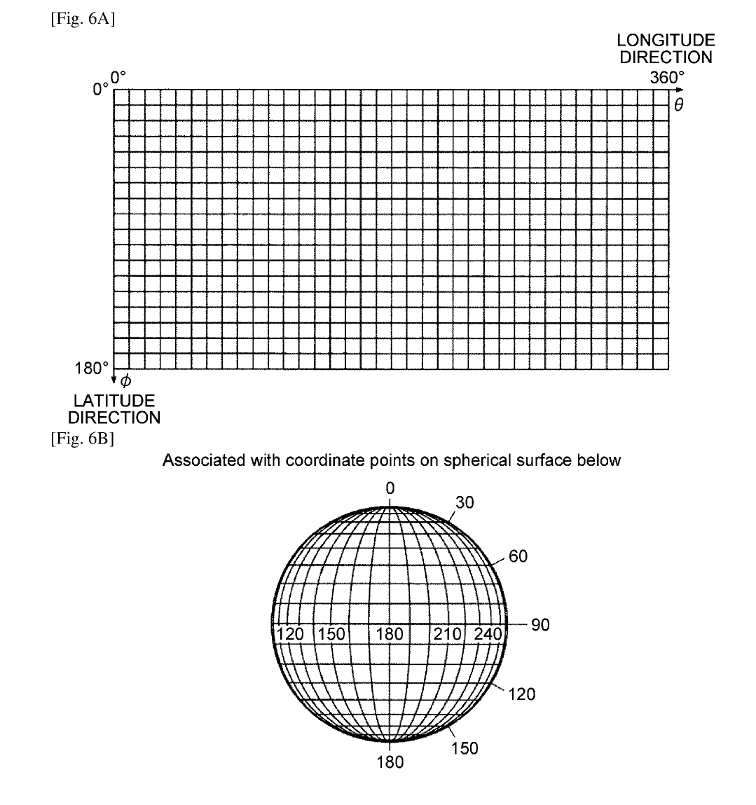

A format (form of expression) of an omnidirectional (full-spherical) image captured by the digital camera of the present embodiment is described below. FIGS. 6A and 6B are diagrams describing the format of an omnidirectional (full-spherical) image captured by the digital camera of the present embodiment presented in a planar form (FIG. 6A) and a spherical form (FIG. 6B).

Referring to FIGS. 6A and 6B, the format of the omnidirectional (full-spherical) image is such that, when developed onto a plane as illustrated in FIG. 6A, the image has pixel values at angular coordinates of horizontal angles from 0 to 360 degrees and vertical angles from 0 to 180 degrees. The angular coordinates are associated with respective coordinate points on the spherical surface illustrated in FIG. 6B and substantially equivalent to latitude/longitude coordinates on a globe.

Planar coordinate values of an image captured with a fisheye lens and full-spherical coordinate values of an omnidirectional (full-spherical) image can be associated using the projection function f (h=f×φ) described with reference to FIGS. 5A and 5B. Hence, such an omnidirectional (full-spherical) image as that illustrated in FIGS. 6A and 6B can be generated by transforming two images captured with fisheye lenses and joining (combining) them.

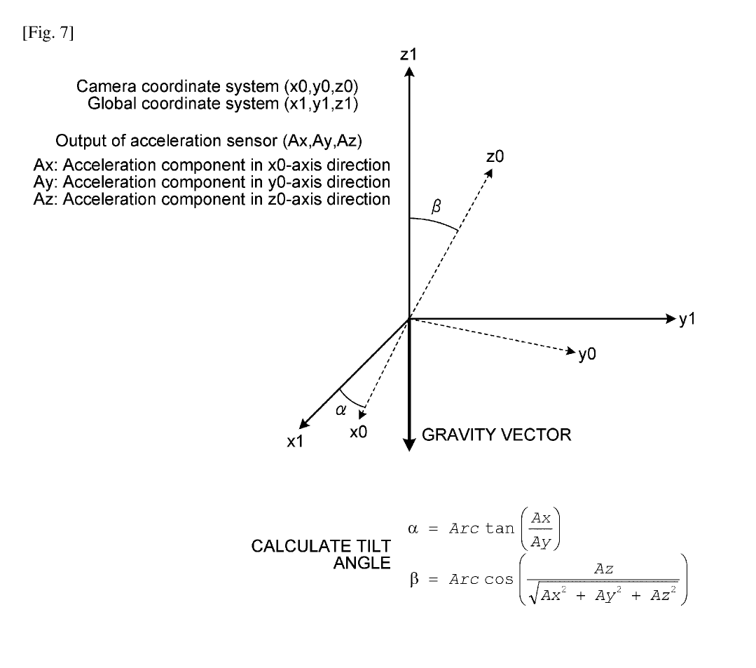

Tilt of the full-spherical camera of the present embodiment is described below. FIG. 7 is a schematic diagram describing a tilt of the full-spherical camera of the present embodiment.

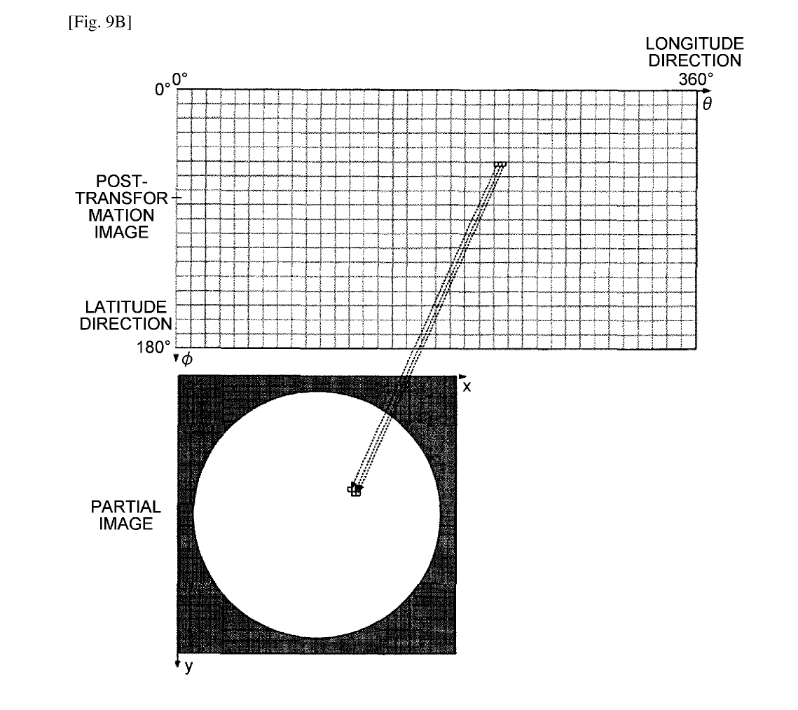

In FIG. 7, the vertical direction coincides with the z1-axis of the x1-y1-z1 three-dimensional Cartesian coordinate system, which is a global coordinate system. When this direction coincides with the orientation of the digital camera illustrated in FIGS. 9A and 9B, the camera is in a non-tilted state. When they do not coincide, the digital camera is in a tilted state.

An inclination angle β relative to the gravity vector and a slope angle α in the x1-y1 plane can be obtained using an output of the acceleration sensor from Equation (1) below. In Equation (1), Ax is a value of an x0-axis direction component in the camera coordinate system of the acceleration sensor, Ay is a value of a y0-axis direction component in the camera coordinate system of the acceleration sensor, and Az is a value of a z0-axis direction component in the camera coordinate system of the acceleration sensor.

$$α = Arctan ( \frac{Ax}{Ay} ) \\ β = Arccos ( \frac{Az}{\sqrt{{Ax}^{2} + {Ay}^{2} + {Az}^{2}}} ) \qquad ( 1 )$$

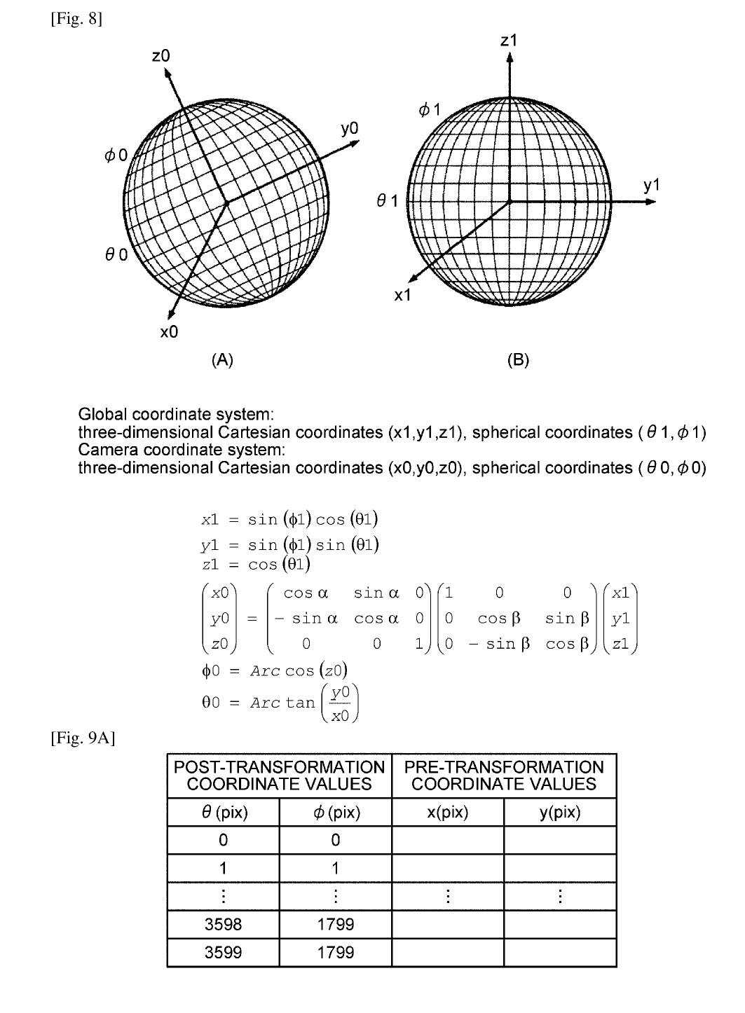

Vertical correction calculation is described below. FIG. 8 is a diagram describing vertical correction calculation for an omnidirectional (full-spherical) image captured by the digital camera of the present embodiment using (A) the camera coordinate system and (B) the global coordinate system.

In FIG. 8, three-dimensional Cartesian coordinates in the global coordinate system are denoted by (x1,y1,z1), and spherical coordinates are denoted by (Θ1, φ1). Three-dimensional Cartesian coordinates in the camera coordinate system are denoted by (x0,y0,z0) and spherical coordinates are denoted by (Θ0,φ0).

Transformation from the spherical coordinates (Θ1,φ1) to the spherical coordinates (Θ0,φ0) is performed using equations presented in FIG. 8. Performing rotational transformation using three-dimensional Cartesian coordinates is required to correct a tilt. Accordingly, transformation from the spherical coordinates (Θ1,φ1) to the three-dimensional Cartesian coordinates (x1,y1,z1) is performed using the equations presented in FIG. 8.

Thereafter, transformation from (x1,y1,z1) in the global coordinate system to (x0,y0,z0) in the camera coordinate system is performed using a camera tilt parameter (α,β) by the rotational coordinate transformation presented in FIG. 8. Put another way, the camera tilt parameter (α,β) is defined.

This means that transformation from the global coordinate system to the camera coordinate system is achieved by rotating around the z1-axis by α and further rotating around the x1-axis by β. Finally, the three-dimensional Cartesian coordinates (x0,y0,z0) in the camera coordinate system are transformed back to the spherical coordinates (Θ0,φ0) in the camera coordinate system using the equations presented in FIG. 8.

A method for tilt correction using the conversion table is described below. FIG. 9A illustrates a conversion table for an omnidirectional (full-spherical) image captured by the digital camera of the present embodiment.

FIG. 9A is a diagram illustrating a matrix of coordinate values of a post-transformation image and a pre-transformation image to describe the conversion table (or conversion data). FIG. 9B is a diagram describing a relationship between coordinate values of the post-transformation image and coordinate values of the pre-transformation image.

As illustrated in (a) of FIG. 9A, the conversion table for use in image transformation contains a data set of coordinate values (θ,φ)(pix: pixel) of the post-transformation image and corresponding coordinate values (x,y)(pix) of the pre-transformation image for each of coordinates of the post-transformation image. Although the presented conversion table has a tabular data structure, the data structure is not limited to a tabular form. In short, it is required only that the conversion table be conversion data.

A post-transformation image is generated from a captured image (pre-transformation image) in accordance with the conversion table illustrated in FIG. 9A. Specifically, as illustrated in FIG. 9B, pixels of the post-transformation image are generated by referring to pixel values at coordinate values (x,y)(pix) of the pre-transformation image associated with coordinate values (θ,φ)(pix) based on correspondence between the pre-transformation image and the post-transformation image in the conversion table illustrated in FIG. 9A.

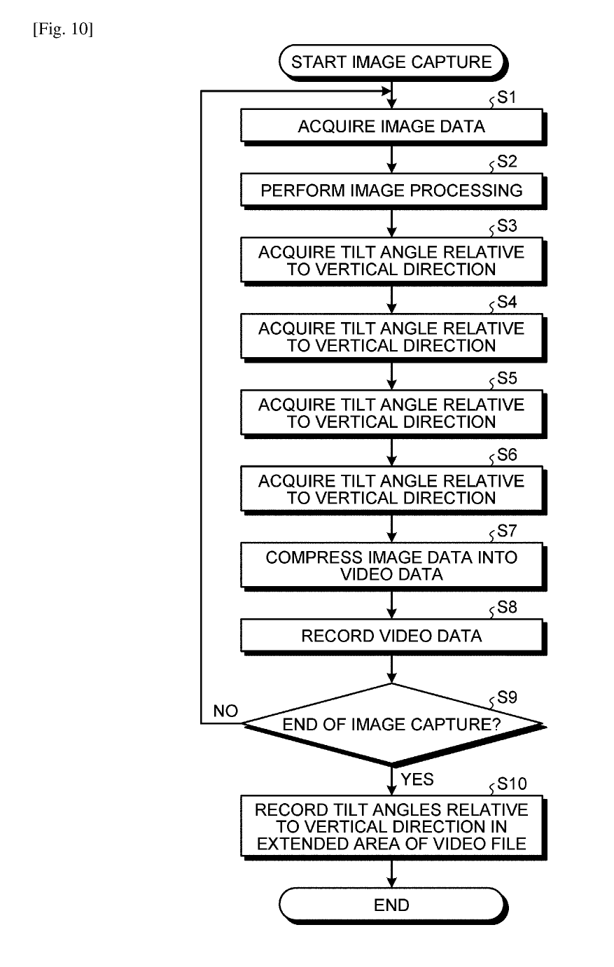

An implementation example of the present invention is described below. FIG. 10 is a flowchart of the present embodiment. The description below is made with reference to the flowchart of FIG. 10. In the present embodiment, image capture is performed in a video capture mode by placing the image capture apparatus in the video capture mode.

When video capture is started, acquisition of captured image data is performed in accordance with a predetermined cycle time (step S1).

When acquisition of the image data is completed, predetermined image processing is performed (step S2). Image processing performed at this stage denotes general image processing, such as distortion correction and defective pixel correction, and is not tilt angle correction. Thereafter, the acquisition unit 11 acquires tilt angles relative to the vertical direction from the acceleration sensor in accordance with a predetermined cycle time (step S3 to step S6). In an example of the present embodiment, tilt-angle acquisition is performed with a cycle time, which is “¼” the image-data-acquisition cycle time as described above.

When acquisition of the image data and the tilt angles is completed, the image data is compressed into video data (step S7). The compressed video is recorded in a predetermined recording medium (step S8). The above is processing for one frame. Thereafter, processing (from step S1 to step S8) is performed similarly on every frame until the image capture ends (until “YES” is determined at step S9).

When the image capture ends, information about the tilt angles is recorded in an expansion area of the video data stored in the recording medium (step S10). As described above, information about total six tilt angles, which are a tilt angle in sync with the acquired image data and in the same cycle as the acquired image data and tilt angles acquired within cycles straddling the acquisition of the image data, is also handled as tilt-angle information related to the image data and recorded.

What has hitherto been described is processing performed in a main body of the image capture apparatus.

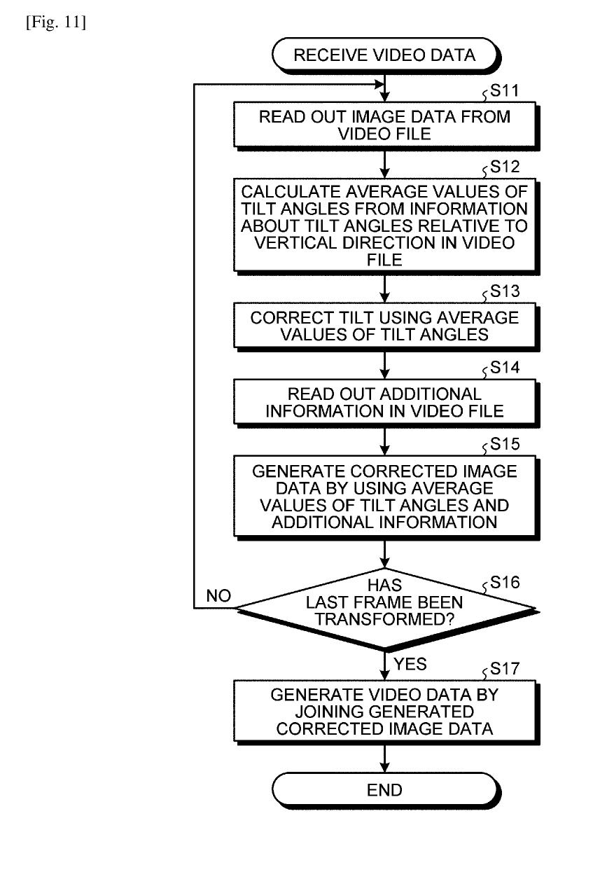

The information processing apparatus of the present embodiment is described below. In the present embodiment, an image processing apparatus is used as an example of the information processing apparatus. FIG. 11 is a flowchart for the information processing apparatus of the present embodiment. The description below is made with reference to the flowchart of FIG. 11.

The information processing apparatus acquires the video data processed by the image capture apparatus (step S11). Acquisition of the video data may be performed by any method for data transmission and reception. Examples of the method include wired or wireless network communication and use of an external storage.

The calculator 21 calculates average values on a per-frame basis from the information about the tilt angles recorded in the acquired video file (step S12).

The tilt angle can be calculated from the data obtained from the acceleration sensor by calculating the camera tilt parameter, which is described above in paragraphs [0040] through [0048], concerning the camera coordinate system and the global coordinate system. The acceleration data is three-axis coordinates in the X direction, the Y direction, and the Z direction in each of the coordinate systems.

When the average tilt angles have been calculated, the generator 31 performs tilt angle correction relative to the vertical direction on a per-frame basis (step S13). The tilt angle correction is performed using the conversion table described in paragraphs [0049] through [0054]. The conversion table is stored in a predetermined recording unit, e.g., a RAM. The tilt angle correction is performed in accordance with predetermined program instructions.

When the tilt angle correction is completed, additional information in the video file is read out (step S14). The additional information includes time information and audio information for use in displaying video data.

Corrected image data having undergone the tilt angle correction is generated using the calculated average tilt angles and the additional information in the video file (step S15).

Generating the corrected image data is performed on memory in a state of being stored in a recording medium, e.g., a RAM, rather than by temporarily converting the video file into a still-image file. This scheme allows fast completion of processing. The above is performed by the generator 31. Thereafter, processing (from step 11 to step 15) by the calculator 21 and the generator 31 is performed in a similar manner until every frame has been processed (until “YES” is determined at step S16).

When corrected image data has been generated for all the frames, the corrected image data is joined to encode it into an equirectangular video (step S17).

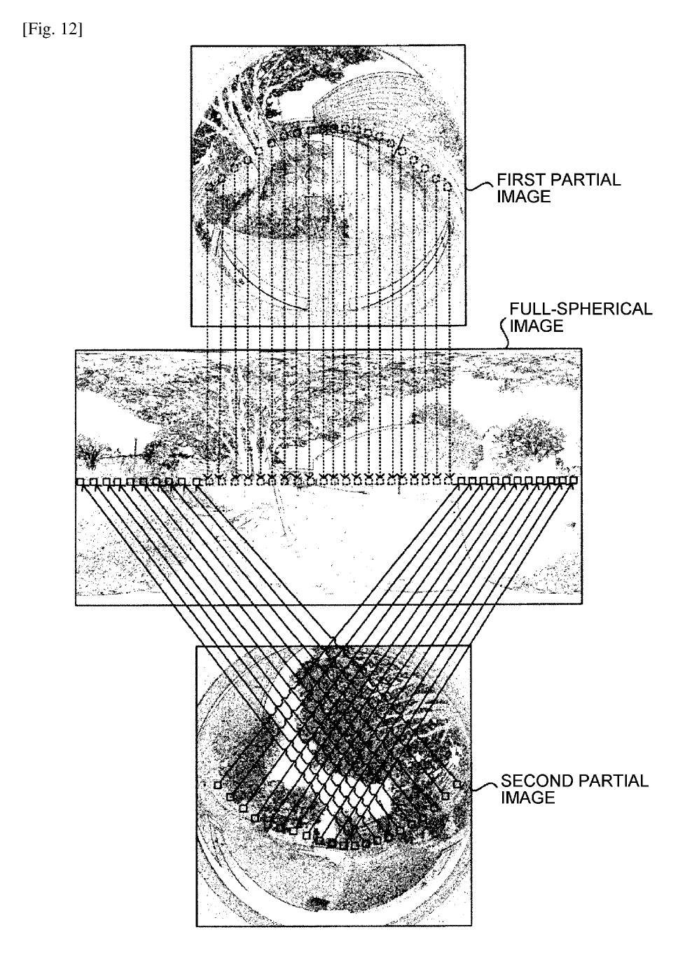

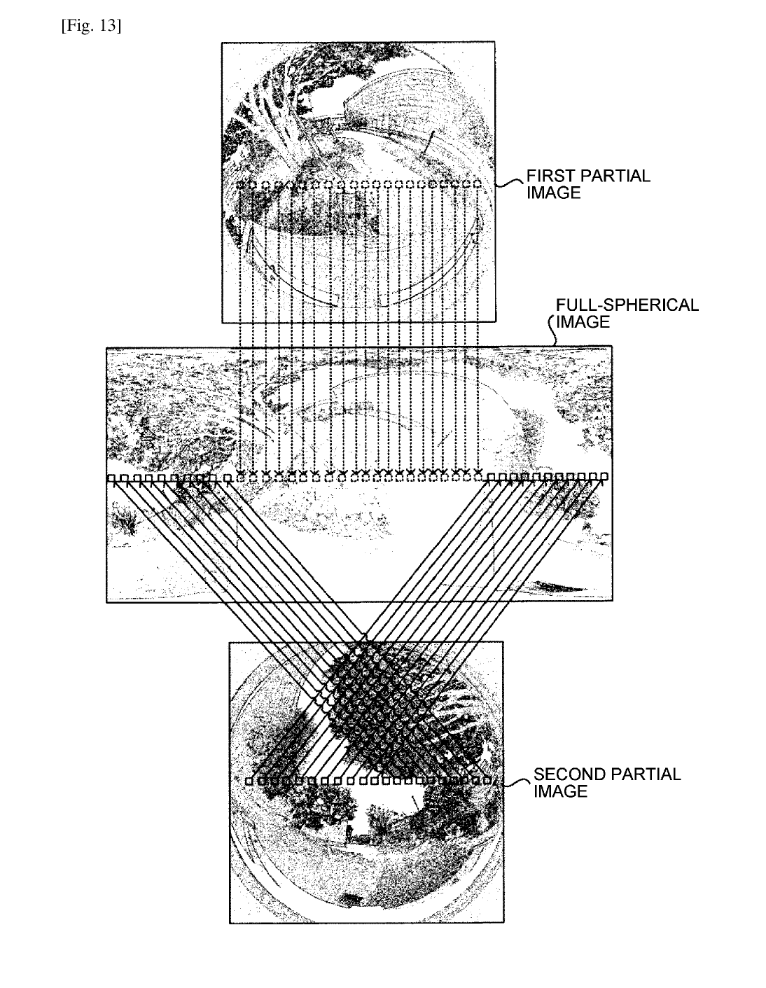

FIG. 12 is a set of still images of a video having undergone the tilt angle correction of the present embodiment and then encoded. FIG. 13 is a set of still images of a video encoded without having undergone the tilt angle correction of the present embodiment.

Difference between FIG. 12 and FIG. 13 is apparent in distortion of image plane relative to the upward vertical direction and in horizontal plane. In FIG. 13, because the upward vertical direction is not fixed, the image plane appears to be a spherical surface.

Referring to FIG. 12, applying the tilt angle correction of the present invention causes the upward vertical direction to be reproduced clearly even if the image capture apparatus is tilted, thereby providing a video image substantially equivalent to that obtained with the image capture apparatus not tilted but horizontally situated.

As described above, the present invention allows acquiring, by using the omnidirectional (full-spherical) image capture apparatus and the information processing apparatus, tilt angles from the acceleration sensor with a cycle time which is “¼” the image-data-acquisition cycle time, thereby achieving highly-accurate tilt angle correction. Furthermore, by performing tilt-angle-corrected image data on memory, high-speed processing can be achieved.

A preferred example of the present embodiment has been described above. Although description has been made through the specific example, various modification, alteration, and the like can be made on the present specific example without departing from the spirit and scope of the appended claims.

Because application of the tilt angle correction to image data making up video data, generation of corrected image data, and the like presumably require equipment having high specification in terms of function, the imaging system of the present invention includes two pieces of equipment, which are the full-spherical camera and the image forming apparatus.

For instance, if an image capture apparatus capable of implementing the imaging system of the present invention is available, the need for using the information processing apparatus such as the image forming apparatus can be eliminated.

Elements of the apparatuses used in the imaging system of the present invention, the number of the apparatuses, and the like are not limited to those of the present embodiment as long as the imaging system can be implemented.

The above-described embodiments are illustrative and do not limit the present invention. Thus, numerous additional modifications and variations are possible in light of the above teachings. For example, at least one element of different illustrative and exemplary embodiments herein may be combined with each other or substituted for each other within the scope of this disclosure and appended claims. Further, features of components of the embodiments, such as the number, the position, and the shape are not limited the embodiments and thus may be preferably set. It is therefore to be understood that within the scope of the appended claims, the disclosure of the present invention may be practiced otherwise than as specifically described herein. Further, any of the above-described apparatus, devices or units can be implemented as a hardware apparatus, such as a special-purpose circuit or device, or as a hardware/software combination, such as a processor executing a software program.

Further, as described above, any one of the above-described and other methods of the present invention may be embodied in the form of a computer program stored in any kind of storage medium. Examples of storage mediums include, but are not limited to, flexible disk, hard disk, optical discs, magneto-optical discs, magnetic tapes, non-volatile memory, semiconductor memory, read-only-memory (ROM), etc. Alternatively, any one of the above-described and other methods of the present invention may be implemented by an application specific integrated circuit (ASIC), a digital signal processor (DSP) or a field programmable gate array (FPGA), prepared by interconnecting an appropriate network of conventional component circuits or by a combination thereof with one or more conventional general purpose microprocessors or signal processors programmed accordingly.

### REFERENCE SIGNS LIST

11 Acquisition unit
21 Calculator
31 Generator
110 Full-spherical camera
150 Image processing apparatus

### CITATION LIST

### Patent Literature

PTL 1: Japanese Laid-open Patent Publication No. 2013-214947

PTL 2: Japanese Laid-open Patent Publication No. 2010-271674

PTL 3: Japanese Laid-open Patent Publication No. 2010-271675

1. A full-spherical video imaging system comprising:
an acquisition unit configured to acquire tilt angles relative to a vertical direction from an image sensor with a second cycle time being shorter than a first cycle time with which the acquisition unit acquires original image data from the image sensor;
a calculator configured to calculate an average tilt angle from a tilt angle of the image sensor relative to the vertical direction acquired simultaneously with acquisition of the original image data and a tilt angle of the image sensor relative to the vertical direction acquired in a period straddling the acquisition of the original image data; and
a generator configured to generate corrected image data by correcting original image data based on the average tilt angle.

2. The full-spherical video imaging system according to claim 1, wherein the acquisition unit calculates a tilt angle of the image sensor relative to the vertical direction from acquired acceleration in three-dimensional directions.

3. The full-spherical video imaging system according to claim 1, wherein the calculator calculates the average tilt angle from three tilt angles, the three tilt angles being the tilt angle of the image sensor relative to the vertical direction acquired simultaneously with acquisition of the original image data, a tilt angle of the image sensor relative to the vertical direction acquired immediately before the acquisition of the original image data, and a tilt angle of the image sensor relative to the vertical direction acquired immediately after the acquisition of the original image data.

4. The full-spherical video imaging system according to claim 1, wherein the calculator calculates the average tilt angle from the tilt angle of the image sensor relative to the vertical direction acquired simultaneously with acquisition of the original image data and all of tilt angles acquired within cycles, of the first cycle time, straddling the acquisition of the original image data.

5. The full-spherical video imaging system according to claim 1, wherein the second cycle time is “one over a whole number” the first cycle time.

6. The full-spherical video imaging system according to claim 1, wherein the generator generates the corrected image data on memory.

7. A non-transitory computer-readable recording medium that contains computer program instructions for causing, when executed, one or more computers to perform:
acquiring tilt angles relative to a vertical direction from an image sensor with a second cycle time being shorter than a first cycle time with which original image data is acquired from the image sensor;
calculating an average tilt angle from a tilt angle of the image sensor relative to the vertical direction acquired simultaneously with acquisition of the original image data and a tilt angle of the image sensor relative to the vertical direction acquired in a period straddling the acquisition of the original image data; and
generating corrected image data by correcting the original image data based on the average tilt angle.

8. The full-spherical video imaging system according to claim 5, wherein the second cycle time is “one-quarter” the first cycle time.

9. The non-transitory computer-readable recording medium according to claim 7, wherein the second cycle time is “one over a whole number” the first cycle time.

10. The non-transitory computer-readable recording medium according to claim 9, wherein the second cycle time is “one-quarter” the first cycle time.
